(19) United States
(12) Patent Application Publication
(10) Pub. No.: US 2023/0071888 A1
(43) Pub. Date: Mar. 9, 2023

(54) ODOR- AND EMISSION-REDUCED ANTI-CORROSION AGENT

(71) Applicant: Pfinder KG, Boeblingen (DE)

(72) Inventors: Mark BADER, Kirchheim (DE); Christian SCHALLER, Neuhausen (DE); Mario GILLMEISTER, Esslingen (DE); Hans-Friedrich STAENGLE, Marbach (DE); Karsten LESSMANN, Rottenburg (DE)

(21) Appl. No.: 17/965,982

(22) Filed: Oct. 14, 2022

Related U.S. Application Data
(63) Continuation of application No. PCT/EP2021/059697, filed on Apr. 14, 2021.

(30) Foreign Application Priority Data
Apr. 24, 2020 (DE) 10 2020 111 288.2

(51) Int. Cl. C23F 11/173; C23F 11/12

(52) U.S. Cl. CPC C23F 11/173; C23F 11/122; C23F 11/124

(57) ABSTRACT

The invention relates to the use of a composition for the preparation of an odor- and emission-reduced corrosion inhibitor for cavity sealing or underbody protection of a component, wherein the composition comprises a resin, wherein the resin comprises a plurality of molecules, wherein the plurality of molecules comprise molecules without double allyl hydrogen atoms, and wherein the odor- and emission-reduced corrosion inhibitor is applied to the component with a wet film thickness of 40 μm to 1,000 μm.

### CROSS-REFERENCE TO RELATED APPLICATIONS

This application is a continuation of international patent application PCT/EP2021/059697 filed on Apr. 14, 2021 designating the U.S., which international patent application has been published in German language and claims priority from German patent application DE 10 2020 111 288.2, filed on Apr. 24, 2020. The entire contents of these priority applications are incorporated herein by reference.

### BACKGROUND

The present invention relates to a corrosion protection for solid surfaces. In particular, the present invention relates to the use of a composition for the preparation of an odor- and emission-reduced corrosion protection agent for cavity sealing or underbody protection of a component, in particular a motor vehicle component. In this regard, the composition comprises a resin. The resin has a plurality of molecules. The plurality of molecules has molecules without double allylic hydrogen atoms. The composition is applied to the component with a wet film thickness of 40 μm to 1,000 μm.

Corrosion inhibitors that are used particularly in cavity preservation (HRC), i.e., in cavities such as those found in vehicle bodies, are well known in the state of the art. Cavity preservatives are known in particular from vehicle construction and, after application, for example on a metallic substrate, offer good protection against corrosion triggered, for example, by the action of water or by moist ambient air.

Generally, there are two different types of cavity preservatives: Flooding waxes and spray waxes. In the prior art, common cavity preservatives for spray application contain waxes and/or resins, functional additives such as corrosion protection additives, formulation additives such as rheological or dispersing aids, and inorganic fillers. These ingredients are dispersed either in an aqueous medium (aqueous cavity preservative) or in a non-polar organic solvent (solvent-containing cavity preservative). So-called 100% cavity preservatives without solvents are also available.

To achieve uniform distribution of the sprayed cavity preservative into the components, products with low viscosity are generally used to achieve uniform wetting of the component surface and good penetration of folds. On the one hand, low viscosities are necessary to achieve the best possible uniform wetting, and on the other hand, after all relevant areas of the components have been wetted, the cavity preservative should stop flowing in order to prevent the cavity preservative from dripping out of the application nozzle openings of the components. Depending on the component, a lower or higher viscosity is required to allow the cavity preservative to run throughout the component. However, since it is generally not possible to adjust the rheology individually, an average rheology of the material is selected so that the components are wetted as completely as possible and yet no dripping occurs.

The necessary increase in viscosity after application is achieved in the case of solvent-containing cavity preservatives and aqueous cavity preservatives by evaporation of the medium, i.e., the solvent or water. In the case of 100% cavity preservatives, this increase in viscosity is achieved by a temperature increase (for example, 1 min at 60° C.). This temperature increase triggers gelation of the cavity preservative after cooling, the so-called drop stop, which prevents dripping of the cavity preservative and thus guarantees process reliability. The disadvantage here is that the use of ovens results in energy and investment costs for the customer or original equipment manufacturer (OEM); in addition, it is difficult to ensure a constant temperature increase across all coating thicknesses.

After evaporation of the medium or gelation of the cavity preservative, a film is formed on the coated surface to protect against corrosion. In the further course of operation of the cavity preservation, good heat stability is necessary so that when the component is reheated, the filmy cavity preservation does not become liquid again or can leak out, and the strength of the corrosion protection films is given in a range from −20 to +90° C. In the case of solvent-containing cavity preservatives and 100% cavity preservatives, the heat resistance is generally achieved by chemical crosslinking of components containing solvents, such as the oxidative crosslinking or drying of alkyd resin, which takes about three to five days to complete.

Overall, the application of the cavity preservative is a two-step process: 1. targeted application and immediate flow with sufficient penetration of the cavity preservative and a controllable viscosity increase, if necessary, and 2. chemical crosslinking during/after viscosity increase to effect long-term thermal stability.

This long drying or crosslinking time, often incomplete drying, and the average rheology of the material for all individual piercing holes or setting points are disadvantages in conventional 100% cavity preservatives. For this reason, drip lines are often required for controlled dripping of undried cavity preservation, and components such as sills are masked off. This increases the process costs for the preservation and often requires manual post-treatment to remove residues of the cavity preservation. Another disadvantage of these oxidatively crosslinking cavity preservatives (solvent-containing cavity preservatives and 100% cavity preservatives) is the formation of fission products. These are mainly C₅ to C₉ aldehydes and the corresponding carboxylic acids formed from them by oxidation, which can contribute to overall emissions and odor in the vehicle interior. Every original equipment manufacturer specifies strict limits for this, some of which are difficult to achieve.

One difficulty that arises is that trouble-free application and good heat stability of a corrosion protection agent, for example a corrosion protection agent for cavity preservation or for underbody protection, can only be guaranteed by aiming for a one-component mixture for the crosslinking reaction. However, the technology used today, which is mainly based on alkyd resin, causes emissions and odor. Other binder technologies, however, do not or at best only partially fulfill the necessary criteria such as a one-component system, non-labeling, storage stability, crosslinking at room temperature, etc.

Therefore, the object of the present invention is to provide a composition that can be used to prepare an odor- and emission-reduced corrosion protection agent for cavity sealing or for underbody protection of a component. Furthermore, to provide the use of a composition for the preparation of an odor- and emission-reduced corrosion protection agent for cavity sealing or for underbody protection of a component, in which the above-mentioned difficulties are solved. A further object of the present invention is to provide a use in which reduced emission and, in particular, reduced odor occur. Still another problem consists in providing a use of a composition containing a polyester resin and/or an alkyd resin for the production of an odor- and emission-reduced corrosion protection agent for cavity sealing or for underbody protection of a component, wherein the composition has increased stability.

### SUMMARY

According to the invention, the above-mentioned tasks are solved by providing the use of a composition for the preparation of an odor- and emission-reduced corrosion protection agent for cavity sealing or for underbody protection of a component,

wherein the composition comprises a resin, the resin comprising a plurality of molecules, the plurality of molecules comprising molecules without double allylic hydrogen atoms, and

wherein the composition is applied to the component with a wet film thickness of 40 μm to 1,000 μm.

In a double allylic hydrogen atom, one hydrogen atom is in allylic position to two double bonds. The underlying structural feature thus has two double bonds and an intervening CHR group, where R can be H or any other radical. The simplest exemplary representative of a compound having a double allyl hydrogen atom represents 1,4-pentadiene. Another exemplary representative of a compound having a double allylic hydrogen atom is linoleic acid or a linoleic acid ester.

It was found that molecules with a double allylic hydrogen atom are particularly susceptible to the cleavage into, among others, short-chain aldehydes that occurs during oxidative crosslinking. This can be counteracted by reducing the number of molecules with at least one double allylic hydrogen atom. This is preferably done in such a way that at the same time the crosslinking ability is maintained and thus the number of (transversely) crosslinking double bonds is not reduced. These (transversely) crosslinking double bonds are thus contained in the resin in the form of isolated and/or accumulated double bonds.

The “composition for the preparation of an odor- and emission-reduced corrosion protection agent for cavity sealing or for underbody protection of a component”, also referred to as “corrosion protection agent” in the context of the present application, is characterized by the fact that the resin contained therein has odor- and emission-reduced properties due to a low content of double allylic hydrogen atoms.

As mentioned above, a low content of double allylic hydrogen atoms can be achieved in several ways. On the one hand, it is possible to use one or more resins that do not contain any double allylic hydrogen atoms from the outset, but only other groups accessible to crosslinking, e.g., isolated and/or accumulated C—C double bonds. Furthermore, the proportion of one or more resins with double allylic hydrogen atoms can be reduced by adding either one or more resins without double allylic hydrogen atoms (also molecules without double allylic hydrogen atoms).

Alternatively, or additionally, the one or more resins containing double allylic hydrogen atoms (molecules) may be subjected to a chemical reaction. This chemical reaction removes the double allylic hydrogen atoms (or reduces the content of double allylic hydrogen atoms in the resin), while preferably at the same time not reducing, or only slightly reducing, the number of double bonds to maintain sufficient crosslinking capability. A preferred example of such a chemical reaction is provided by the Diels-Alder reaction, in which one or both of the C—C double bonds contained in a group containing a double allylic hydrogen atom is reacted as a dienophile with a diene, e.g., cyclopentadiene.

Consequently, within the scope of the present invention, the formation of odor-intensive compounds, in particular short-chain aldehydes or carboxylic acids, in particular aldehydes or carboxylic acids with 3 to 9 C atoms, such as 4 to 8 C atoms, 5 to 7 C atoms, or 6 C atoms, can be partially, preferably completely, prevented and thus contribute to an emission reduction.

In the context of the present invention, it was further found that the substituted or unsubstituted 1,3-butadiene, hereinafter also referred to as diene, reacts with a double bond or a triple bond of the unsaturated compound, the first molecule, in a Diels-Alder reaction. This double bond or triple bond of the unsaturated compounds acts here as a dienophile. The ring system formed by the [4+2] cycloaddition of the diene to the dienophile has one double bond (addition of the diene to a double bond) or two isolated double bonds (addition of the diene to a triple bond). It can be assumed that these double bond(s) can contribute to further oxidative crosslinking of the first molecule. Since the double bond(s) formed in the Diels-Alder reaction are in a ring system (a substituted cyclohexene or substituted 1,4-cyclohexadiene), even a subsequent oxidative cleavage of a double bond cannot give rise to short-chain aldehydes that contribute to the emission and odor development.

In summary, the inventors have recognized that by reducing the number of molecules containing at least one double allylic hydrogen atom, the oxidative cleavage reaction associated with emissions and odor nuisance can be at least partially, preferably completely, prevented without impairing or even preventing the spatial crosslinking of the corrosion inhibitor. Furthermore, it can be assumed that, due to the reduced proportion or absence of short-chain aldehydes/carboxylic acids, there is a higher homogeneity within the corrosion protection agent compared to conventional corrosion protection coatings. This leads to higher stability and a longer service life of the coating.

Resins used in compositions for the production of an odor- and emission-reduced corrosion protection agent for cavity sealing or for underbody protection of a component are known in the prior art.

The resin may be, for example, an unsaturated polyester, an unsaturated alkyd resin and/or an unsaturated binder. Preferably, moisture-curable prepolymers of the above components and mixtures thereof may be used. Particularly preferably, the resin is an unsaturated alkyd resin. Preferably, the resin is a modified resin having a lower number of double allylic hydrogen atoms than a non-modified resin.

Further preferably, the resin is a medium to long chain organic compound having at least one functional group selected from the group consisting of an amino group, a carboxy group and a hydroxy group. Preferred examples of such compounds include alkyd resins, acrylic resins, polyesters, and native and synthetic oils having OH functionality.

Further preferably, the resin is an organic compound having at least one functional group selected from the group consisting of an amino group, a carboxy group and a hydroxy group. Preferred examples of such compounds include alkyd resins, acrylic resins, polyesters, and native and synthetic oils having OH functionality.

Particularly preferably, the resin is an ester of an unsaturated fatty acid. Preferably, this ester may be derived from a polyhydric alcohol, more preferably from dihydric alcohols (such as ethylene glycol, butanediol, pentanediol, hexanediol, heptanediol, neopentylene glycol, dietylene glycol and/or triethylene glycol), trivalent alcohols (such as glycerol, trimetylolethane and/or trimethylolpropane), tetravalent alcohols (such as pentaerythritol), or hexavalent alcohols (such as dipentaerythritol) or mixtures thereof. Particularly preferably, the ester may be derived from an unsaturated fatty acid of glycerol. Preferably, the ester of an unsaturated fatty acid derived from glycerol may be a triglyceride of an unsaturated fatty acid.

The term “triglyceride” as used herein means triple esters of the trivalent alcohol glycine with an organic carboxylic acid. The organic carboxylic acids may be the same or different from each other. Thus, triglycerides may have three ester groups that are the same or different from each other.

The organic carboxylic acid is preferably a fatty acid, in particular an aliphatic monocarboxylic acid, having about 4 to about 36 carbon atoms, preferably about 8 to about 24 carbon atoms, more preferably about 12 to about 20 carbon atoms. In this regard, the fatty acids may be unbranched or branched, with unbranched fatty acids being preferred.

According to the present invention, at least one of the organic carboxylic acids is an unsaturated fatty acid. The unsaturated fatty acid may have one or more unsaturated bonds, for example one to six unsaturated bonds. Particularly preferably, the unsaturated bonds are present as conjugated double bonds.

Possible monounsaturated fatty acids are undecylenic acid, myristoleic acid, palmitoleic acid, margaroleic acid, petroselinic acid, oleic acid, elaidic acid, vaccenic acid, gadoleic acid, gondoic acid, cetoleic acid, erucic acid and nervonic acid. Possible polyunsaturated fatty acids include linoleic acid, calendulic acid, punicic acid, eleostearic acid, stearidonic acid, arachidonic acid, eicosapentaenoic acid, docosadienoic acid, docosatetraenoic acid, docosapentaenoic acid, docosahexaenoic acid, tetracosahexaenoic acid. Other preferred acids are pelargonic acid, tall oil fatty acids, benzoic acid, p-tert-butylbenzoic acid, versatic acids, abietic acid, stearic acid, isononanoic acid, lauric acid, lactic acid, oleic acid, linolenic acid, palmitoleic acid, gadoleic acid, eleostearic acid, oxoeleostearic acid, erucic acid, gondoic acid, nervonic acid, ricinoleic acid, eicosapentaenoic acid, docosahexaenoic acid, docosapentenoic acid, stearidonic acid and mixtures thereof.

The ester of an unsaturated fatty acid can also be used preferably in the form of a natural oil. Natural oils are oils which can be obtained from plants or animals such as fish. This is particularly preferred because these compounds are obtained from renewable raw materials and are thus advantageous in terms of environmental protection. Preferred vegetable oils include linseed oil, castor oil, soybean oil, peanut oil, sunflower oil, safflower oil, rapeseed oil, tung oil, oiticica oil, cottonseed oil, corn oil, safflower oil, wood oil, beet oil, perilla oil, poppy seed oil, castor seed oil, sesame oil, wheat germ oil, hemp oil, grape seed oil, walnut oil, varnish seed oil, currant seed oil, perilla seed oil or wild rose oil.

Said resins have the advantage that they can be easily (chemically) modified and thereby optimized for use in a composition for preparing an odor- and emission-reduced corrosion inhibitor for cavity sealing or underbody protection of a component. For example, an alkyd resin having double allyl hydrogen atom as a first component may be reacted with a second component, wherein the second component is a substituted or unsubstituted 1,3-butadiene, to form a Diels-Alder product. In the reaction, at least one double bond of the first component is reacted as a dienophile with a substituted or unsubstituted 1,3-butadiene, the second component, in a Diels-Alder reaction.

The resin, for example, an alkyd resin, is composed of a plurality of molecules. A ratio of molecules having at least one double allylic hydrogen atom with respect to a total number of the plurality of molecules is thereby 10⁻², preferably 10⁻³, for example ≤10⁻⁴, ≤10⁻⁵, ≤10⁻⁶, ≤10⁻⁶. Further preferably, no double allylic hydrogen atom or almost no double allylic hydrogen atom is contained. Almost no double allylic hydrogen atom relates to a ratio of, for example, ≤10⁻³ to ≥10⁻⁶, preferably ≤5*10⁻⁴ to ≥5*10⁻⁵, or ≤10⁻⁴ to ≥10⁻⁵.

The number of molecules or molecules with a double allylic hydrogen atom is preferably reduced in a Diels-Alder reaction. The molecules with a double allylic hydrogen atom are the first molecules to be reacted with second molecules.

The second molecules are preferably a substituted or unsubstituted cyclopentadiene (CPD) or a substituted or unsubstituted dicyclopentadiene (DCPD). If the CPD or DCPD reacts with the first component, the cleavable double bond is blocked with simultaneous introduction of a double bond in the Diels-Alder product, which can still be oxidatively crosslinked.

The Diels-Alder product obtained offers the advantage that in a subsequent reaction, in particular in an oxidative crosslinking, no aldehydes are formed which are emitted and are responsible for the odor formation of the corrosion inhibitor. With the corrosion inhibitor according to the invention, the formation of fission products is therefore reduced or, if necessary, completely avoided, in particular of short-chain fission products with a strong odor.

A preferred way to reduce the number of molecules with at least one double allylic hydrogen atom is to perform an upstream Diels-Alder reaction, which leads to a Diels-Alder product that can be converted in an oxidative cleavage of the still unsaturated compound.

The composition is characterized here by the fact that emission or odor development occurring during oxidative crosslinking of the Diels-Alder product can be at least partially reduced, preferably completely eliminated.

The oxidative crosslinking of the Diels-Alder product according to the invention thus results in a coating which is characterized by a higher stability compared to conventional oxidatively crosslinked binder systems for corrosion inhibitors. This is presumably due to the fact that the formation of short-chain degradation products, in particular the aforementioned short-chain aldehydes or carboxylic acids, is prevented or severely restricted, so that a coating of uniform structure or higher homogeneity is obtained.

It is clear that different first molecules and/or different second molecules can be used. Preferably, different first molecules and one type of second molecule, e.g., dicyclopentadiene, are used.

In the context of the present invention, polyunsaturated polyesters, in particular polyunsaturated alkyd resins, whose composition, reactivity, and reaction behavior are familiar to those skilled in the art, are more preferably used as first molecules.

Dicarboxylic acids such as phthalic acid, phthalic anhydride and isophthalic acid are frequently used. This gives alkyd resins greater hardness and resistance to heat and chemicals.

Aliphatic dicarboxylic acids increase the elasticity of the corrosion inhibitor. One or more of succinic acid, adipic acid, azelaic acid, 2,2,4-trimethyladipic acid, sebacic acid, dodecanedicarboxylic acid or dimerized fatty acids can be used for this purpose. Flame retardant properties can be achieved by adding halogen-containing dicarboxylic acids.

Preferably, glycerol is used as the polyol. More preferably, glycerol is combined, for example, with one or more of pentaerythritol, dipentaerythritol, trimethylpropane, trimethylolethane, sorbitol or glycols. This allows high molecular weights and thus high viscosities, fast drying or higher hardnesses to be achieved.

The fatty acids in the alkyd resins influence the properties through their quantity as well as the number of their multiple bonds. A high proportion of unsaturated bonds leads to fast drying and high gloss, but only low lightfastness. Increasing amounts of fatty acids lower the degree of polymerization and branching, viscosity, drying speed and hardness. They increase solubility in organic solvents, e.g., gasoline, and weathering stability. The acids are added in the form of their fats or oils and therefore undergo transesterification.

Depending on the fatty acid content, the state of the art distinguishes between short-oil (22% to 40%), medium-oil (40% to 60%) and long-oil (60% to 70%) alkyd resins.

Exemplary processes for the production of alkyd resins include the melt condensation of polyol, dicarboxylic acid, and fatty acid at temperatures from 200° C. to 240° C. with water splitting without a catalyst. Furthermore, a two-step transesterification of the natural fatty acids can be performed. First, the fatty acid glycerides are reacted with a polyol, e.g., glycerol, at 240° C. to 280° C. in the presence of a catalyst, such as alkaline earth metal alcoholate. The intermediate product is monoglycerides, which are reacted with the dicarboxylic acid in a second stage at 200° C. to 300° C. under inert gas. The reverse route is also possible: particularly when poorly soluble carboxylic acids such as iso- and terephthalic acid are processed, the fat is reacted with the carboxylic acid in the first step, which also serves as an acid catalyst. This is followed by condensation with the polyol. Alkyd resins are also produced by azeotropic distillation, usually in xylene. The properties of alkyd resins can be modified by copolymerization, reaction or mixing with other substances. For example, natural resins improve gloss and adhesion, phenolic resins increase water resistance, styrene improves drying and chemical resistance, epoxies improve corrosion resistance, silicone improves color, gloss, and temperature stability, and diisocyanates improve drying, hardness, and abrasion resistance.

The resins, e.g., unsaturated polyesters, preferably unsaturated alkyds, or alkyd resins, can link with each other in an oxidative crosslinking reaction, preferably in the presence of atmospheric oxygen at elevated temperatures, in order to cure. According to the Römpp Chemie Lexikon, Georg Thieme Verlag Stuttgart, 9th extended and revised edition 1989, the alkyd resins formed by spatial crosslinking of the alkyds are polyester resins modified with natural fats and oils and/or synthetic fatty acids. They are produced by esterifying polyhydric alcohols, at least one of which is trivalent, with polybasic carboxylic acids. Likewise, fatty acid-free polyesters made from phthalic acid (anhydride) and glycerol can also be regarded as alkyd resins.

Oxidative crosslinking or (cross-) crosslinking is a reaction that usually takes place during drying/curing of the composition. The reaction is triggered by oxygen, preferably atmospheric oxygen, or an oxygen-containing chemical compound which is added to the composition, and which releases the oxygen in a controlled manner, e.g., in the course of heating the compound.

Drying” is understood to mean both “allowing” the corrosion protection agent to dry without any special chemical or physical ambient conditions, e.g., by allowing the corrosion protection agent to dry at room temperature and without any special or modified air environment. On the other hand, “drying” is also understood to mean forced drying, e.g., by drying the corrosion protection agent at an elevated temperature.

In the following, Reaction Scheme 1 shows a schematic representation of the oxidative crosslinking of an alkyd, namely a linoleic acid ester, where the ester residue is represented by R. It is clear that this schematic representation serves only as an example and any unsaturated alkyd resin or mixture of different alkyd resins can be used. In the context of oxidative crosslinking, (1) describes the actual oxidation with O₂, (2) describes the initiation by a Me (II) salt, for example a Co (II) salt such as cobalt dichloride, (3) describes the chain propagation with another linoleic acid ester molecule, and (4) describes the termination reaction.

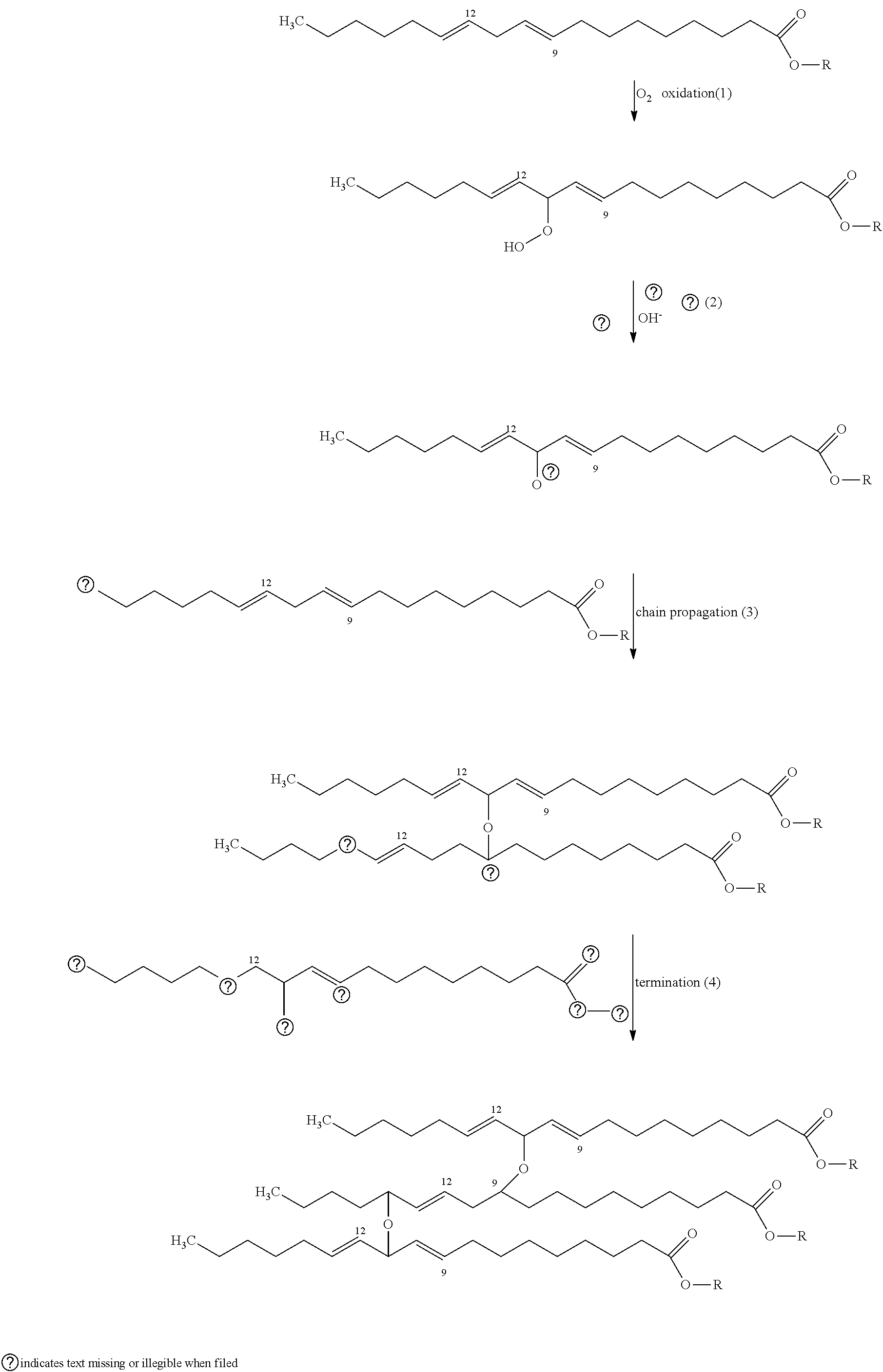

Reaction scheme 1: Exemplary representation of the oxidative crosslinking of an alkyd resin using a linoleic acid ester.

In reaction scheme 2, the above-mentioned linoleic acid ester (with the ester residue R) is used to show the formation of the undesirable cleavage products, in particular the short-chain odor-intensive cleavage products of an alkyd resin during oxidative crosslinking. (1) shows here the addition of O₂ to a linoleic acid ester molecule, (2) the formation of a free radical by the splitting off of an OH radical, and (3) the subsequent cleavage into a short-chain aldehyde and an ester with a terminal double bond.

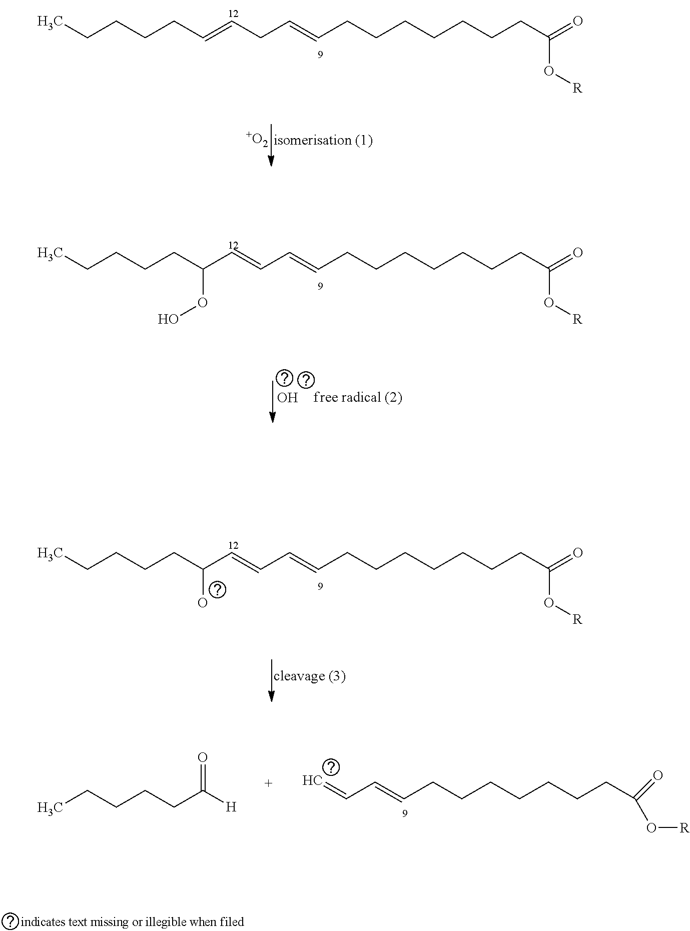

Reaction diagram 2: Example of the formation of cleavage products of an alkyd resin based on a linoleic acid ester during oxidative crosslinking.

Reaction scheme 3 shows the Diels-Alder reaction, which takes place in the corrosion inhibitor of the invention between the first molecule(s) and the second molecule(s). Here, the dicyclopentadiene reacts with the double bonds of linseed oil acting as a dienophile. It can be seen that dicyclopentadiene reacts with various double bonds of linseed oil to form a (substituted) norbornene ring system. The double bonds obtained by the Diels-Alder reaction may contribute to the oxidative crosslinking of the alkyd resin. It can be assumed that the double bond of the (substituted) norbornene ring system is also susceptible to the occurring oxidative cleavage of the double bond. Due to the presence of the (substituted) norbornene as a bicycle, the double bond can indeed be cleaved during the oxidative cleavage reaction. However, this does not lead to the cleavage of a short-chain aldehyde.

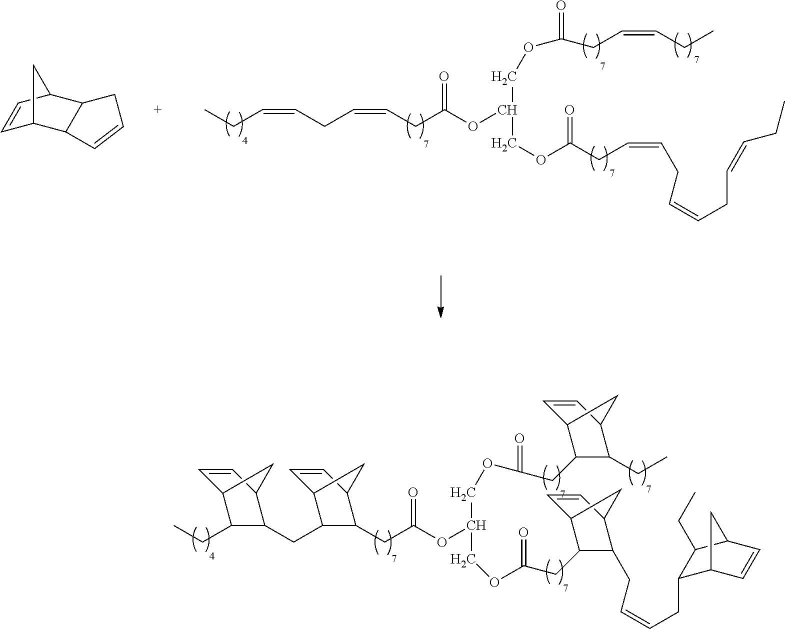

Reaction scheme 3: Exemplary reaction of an alkyd resin with dicyclopentadiene (DCPD) on a linoleic acid residue.

The substituted 1,3-butadiene is preferably in an s-cis configuration.

The term “s-cis configuration” is familiar to those skilled in the art and denotes that the double bonds between C₁ and C₂ or C₂ and C₃ of the substituted 1,3-butadiene are present in cis configuration with respect to the single bond between C₂ and C₃ of the substituted 1,3-butadiene. The presence of the s-cis configuration in the context of the present invention includes the predominant presence, preferably stable, of the substituted 1,3-butadiene in the said s-cis configuration, i.e., that the free rotatability about the C₂-C₃ single bond is either completely excluded, for example in the case of cyclopentadiene (or dicyclopentadiene) or 1,3-cyclohexadiene, or is at least sterically favored by the presence of corresponding residues/substituents on the substituted 1,3-butadiene.

Advantageously, the s-cis configuration is a planar configuration, i.e., the four carbon atoms of the 1,3-butadiene are present in one plane. However, it is clear to the person skilled in the art that slight torsion angles of, for example, 30° or less, preferably 15° or less, lower the reactivity of the diene with respect to the reaction with the dienophile, but do not necessarily prevent this reaction.

Any substituted 1,3-butadiene can be used as substituted 1,3-butadiene. The substituted 1,3-butadiene preferably has a molecular weight of more than 54.9 g/mol (thus above the molecular weight of 1,3-butadiene) and 250 g/mol, more preferably between 60 g/mol and 150 g/mol, 70 g/mol and 120 g/mol, 80 g/mol and 110 g/mol or 90 g/mol and 100 g/mol. By using comparatively small dienes, i.e., dienes with molecular weights in the above ranges, the reaction of the diene with the unsaturated compound (the dienophile) can be ensured.

Preferably, the substituted 1,3-butadiene is a cyclic compound, more preferably cyclopentadiene and/or 1,3-cyclohexadiene. Cyclopentadiene is particularly preferred.

Cyclopentadiene exists at room temperature in the form of the dimer dicyclopentadiene (DCPD). At elevated temperatures, the two forms are in equilibrium with each other. The terms cyclopentadiene and dicyclopentadiene are therefore to be considered interchangeable in the context of the present invention and are used accordingly. Cyclopentadiene/dicyclopentadiene is particularly suitable in the context of the present invention due to its high reactivity and good manageability.

It is clear that any cyclic compound can be used in which the substituted 1,3-butadiene is in s-cis configuration. These cyclic compounds may have further substituents or residues, preferably at the C₁ or C₁ and C₄ of the 1,3-butadiene structure, but also at one or more other positions of the ring system.

For example, instead of cylcopentadiene or cyclohexadiene, substituted cylcopentadiene or substituted cyclohexadiene can be used. For this purpose, one or more residues with +I effect, more preferably with +M effect, is preferably used as substituent(s). An exemplary preferred substituted cylcopentadiene with increased reactivity compared to unsubstituted cylcopentadiene is 1-methoxy-1,3-cyclopentadiene.

It is preferred that the substituted 1,3-butadiene has a moiety that increases the electron density within the conjugated double bonds of the substituted 1,3-butadiene, preferably wherein the moiety provides a +I effect or +M effect and is located at a C₁ position of the substituted 1,3-butadiene or at a C₁ position and C₄ position of the substituted 1,3-butadiene.

Such substituents, which increase the electron density within the conjugated double bonds of the substituted 1,3-butadiene, including their position with respect to/inside the 1,3-butadiene, are known to the skilled person.

Preferred radicals here are those that produce a positive inductive effect (+I effect) or a positive mesomeric effect (+M effect). Both effects have an electron-shifting effect, whereby the electron density within the conjugated double bonds of the substituted 1,3-butadiene can be increased, with the electron-shifting effect of the +M effect generally being greater than that of the +I effect. The increase in electron density within the conjugated double bonds of the substituted 1,3-butadiene leads to increased reactivity of the diene in the Diels-Alder reaction. Thus, the time course and extent of the reaction of the diene with the dienophile, i.e., the proportion of the dienophile reacted with the diene, can be controlled.

Exemplary radicals with +I effect include alkyl radicals, for example, a methyl radical, ethyl radical, n-propyl radical, i-propyl radical, n-butyl radical, or t-butyl radical.

Exemplary radicals with +M effect include an NH₂ radical, NR₂ radical, OH radical, OR radical, NH(CO)R radical, O(CO)R radical, a substituted aryl radical, a phenyl radical, and halogen radicals, for example bromine, chlorine, iodine, or fluorine. R or the substituent of the aryl radical is preferably an alkyl radical with +I effect, in particular one of the radicals listed above.

Preferably, the resin has multiple double bonds, more preferably, the resin has multiple isolated double bonds, and further preferably, the resin has at least one conjugated double bond. Suitable resins that can be used in the context of the present invention have been discussed and listed above. In particular, conjugated acids, i.e., conjugated fatty acids, are preferably used in the context of the present invention, such as conjugated linoleic acids.

Due to the presence of multiple double bonds in the unsaturated compound, sufficient spatial crosslinking of the composition can be achieved more completely and possibly more quickly.

The term “isolated double bonds” refers here, as is familiar to those skilled in the art, to double bonds that are neither present in cumulated nor conjugated form and are thus separated from one another by at least one sp³-hybridized C-atom. The presence of isolated double bonds can ensure the multiple reactivity of the polyester or alkyd resin. For example, it is expected that in the presence of a cumulative double bond, it will not react with the diene as a dienophile. The same may apply to a conjugated double bond, which may itself react as a diene with a double bond of a substituted or unsubstituted 1,3-butadiene as a dienophile. At the very least, it can be assumed that cumulative or conjugated double bonds have a reduced reactivity with respect to the diene.

It should be noted that those skilled in the art can qualitatively and quantitatively predict or estimate the reactivity of the diene toward the dienophile using frontier orbital theory (see D. I. Schuster, T. M. Weil; J. Am. Chem. Soc., 95-12 (1973), 4092-94), in particular the frontier molecular orbital theory/FMO theory, can be used to predict or estimate. Consequently, the skilled person can predict whether and in what way a Diels-Alder reaction will occur based on the structure of the reactants used. Consequently, statements can be made about the reaction rate of the Diels-Alder reaction and statements can be made about which compound acts as a diene or as a dienophile. On this basis, the skilled person can readily determine which diene enters into a Diels-Alder reaction with a given dienophile.

To increase the reactivity of the individual reactants of the Diels-Alder reaction, a Lewis acid can further be added. Exemplary Lewis acids that can be used for this purpose are B(CH₃)₃, B(OH)₃, BF₃, AlCl₃, CO₂, SO₃, SiCl₄ or BF₅ (see K. N. Houk, J. Am. Chem. Soc, 95 (1973), 4094-96 and E. J. Corey et al, J. Am. Chem. Soc, 126 (2004), 13708-13713).

In the context of the present invention, it was found that by using one or more conjugated double bonds within the first molecule, the formation of odor-intensive compounds, in particular short-chain aldehydes or carboxylic acids, in particular aldehydes or carboxylic acids with 3 to 9 C atoms, such as 4 to 8 C atoms, 5 to 7 C atoms, or 6 C atoms, can be partially, preferably completely, prevented, whereby an emission reduction can be achieved. Here, it is not necessary that the first molecule be reacted in a Diels-Alder reaction.

It is further understood that the Diels-Alder reaction may not necessarily be with the resin, but also a precursor thereof. For example, an unsaturated fatty acid having a double allylic hydrogen atom may be subjected to a Diels-Alder reaction prior to formation of a triglyceride. However, in general, performing a Diels-Alder reaction with the resin is preferred.

The composition may have a drop-stop additive.

Drop-stop additives are particles of solid polymers or waxes with a low softening point. Such corrosion inhibitors with drop-stop additives can be sprayed onto or into a desired component, in particular a motor vehicle component. After any dripping of the anticorrosion agent, the components are briefly heated in a further treatment step to a temperature of 50° C. to 80° C., preferably at least 55° C. This heating leads to the component being sprayed with the anticorrosion additive at the drop-off point. This heating causes the drop-stop additive dispersed in the anticorrosion agent to soften. This results in an increase in gelation/viscosity of the corrosion protection agent, which thereby solidifies to a gel-like consistency. This solidification prevents undesirable dripping of the anti-corrosion agent in further processing steps.

Preferably, the composition comprises further additives, e.g. corrosion protection additives, such as calcium sulfonate, flexibilizers (internal plasticizers), such as mineral oil, fillers, such as talc, kaolin, aluminum hydroxide, silicates or calcium carbonates, rheological additives, such as inorganic thickeners, for example layered silicates such as bentonites, organic or inorganic bases that also contribute to corrosion protection, such as triethylenediamine, catalysts for oxidative curing of the corrosion protection agent, such as manganese salts, and other ingredients, for example to prevent the formation of a skin during standing, such as 2-butanone oxime (MEKO). Likewise, colorants, especially pigments, may be present in the corrosion inhibitor.

In the present invention, quantities indicated in parts by weight refer in each case to 100 parts by weight of the ready-to-use corrosion inhibitor, i.e., the corrosion inhibitor to which all the necessary constituents and, where appropriate, additives have already been admixed.

The first molecule(s) and the second molecule(s), if present, are preferably present in an amount of from 2 to 20 parts by weight, preferably from 4 to 15 parts by weight, based on 100 parts by weight of the composition.

The composition is applied to the component with a wet film thickness of 40 μm to 1,000 μm. Preferably, the wet film thickness is 50 μm to 950 μm, for example 100 μm to 900 μm, 150 μm to 850 μm, 200 μm to 800 μm, 250 μm to 750 μm, 300 μm to 700 μm, 350 μm to 650 μm, 400 μm to 600 μm, 450 μm to 550 μm, or 500 μm to 520 μm.

The wet film thickness relates to the selected coating process, in which the composition is applied to the component in a wet state and the thickness of the film is determined by the selected method of application. This has the advantage that the thickness of the film is determined immediately, and no complete drying of the film is waited for.

Application can be performed, for example, with a squeegee, e.g., a spiral squeegee from BYK-Chemie, or pneumatically with a cup gun, e.g., SataJet®, with a suitable nozzle opening, e.g., 0.8 mm to 1.2 mm, and suitable atomizer pressure, e.g., 3.5 bar. Said nozzle opening and atomizer pressure are suitable for any wet film thickness in the range of 40 to 1,000 μm. The wet film thickness is determined by applying a specific amount of composition.

Coatings applied in this way are dried for 72 h in a two-stage process, preferably as described in paragraphs [0005] and [0006], and can then be subjected to corrosion testing. Here, the corrosion-protective properties of the composition are determined, preferably according to DIN EN ISO 9227, on various substrates. The substrates correspond as standard to the materials used in automotive construction. For example, the steel substrate used is Q-Panel R-36 from Q-Lab Deutschland GmbH, In den Hallen 30, D-66115 Saarbrücken, Germany, with dimensions 76 mm×152 mm and a thickness d=0.81 mm.

According to one embodiment of the present invention, the molecules having no double allylic hydrogen atoms are first molecules, and the plurality of molecules having double allylic hydrogen atoms are second molecules, wherein the number ratio of the first molecules to the second molecules is at least 100.

It is clear to the skilled person that the expressions “molecules” or “first molecule” are interchangeable. Thus, the molecule(s) or the first molecule(s) are the same compound(s). Only for reasons of improved distinguishability, reference may be made to a first molecule(s) when a second molecule(s) is (are) used.

The number ratio of the first molecules to the second molecules is preferably at least 200, for example at least 300, at least 400, at least 500, at least 10³, at least 10⁴, more preferably at least 10⁵. The low content of second molecules can ensure that low emissions/low odors are generated during oxidative crosslinking.

According to another embodiment of the present invention, the resin is a modified resin, wherein the modified resin has a lower number of double allylic hydrogen atoms than a non-modified resin.

The reduction in the number of double allylic hydrogen atoms can be achieved as mentioned above.

According to one embodiment of the present invention, the composition has from 5 to 20% by weight of the resin, based on 100% by weight of the odor- and emission-reduced corrosion inhibitor for cavity sealing or underbody protection. Preferably, the resin is selected from the group consisting of an unsaturated polyester, an unsaturated alkyd resin and an unsaturated binder.

According to another embodiment of the present invention, the resin does not have acrylic resin and/or epoxy resin.

According to one embodiment of the present invention, the composition has from 2 to 8% by weight, preferably from 3.5 to 4.5% by weight, of a wax, based on 100% by weight of the composition.

Preferably, the wax is selected from the group consisting of a mineral/fossil/natural wax, especially kerosene wax, a semi-synthetic wax, a synthetic wax, and a microwax.

According to another embodiment of the present invention, the composition comprises from 40% to 70% by weight, preferably from 48% to 55% by weight, of an oil, based on 100% by weight of the composition.

Preferably, the oil is selected from the group consisting of a mineral oil, especially mineral oils with cuts from 75 to 300. More preferred are cuts from 100 to 275, for example 125 to 250, 150 to 225, or 175 to 200.

According to one embodiment of the present invention, after a reaction, the odor- and emission-reduced corrosion inhibitor for cavity sealing or underbody protection may be exposed to a temperature of 70° C. or more for a period of 5 minutes to 2 hours and/or exposed to a temperature of −15° C. or less for a period of 5 minutes to 2 hours without the reacted odor- and emission-reduced corrosion inhibitor exhibiting detectable changes.

According to another embodiment of the present invention, the odor- and emission-reduced corrosion protection agent for cavity sealing or underbody protection has less than 100 ppm of at least one short-chain aldehyde and/or at least one short-chain carboxylic acid.

Preferably, the at least one short-chain aldehyde and/or the at least one short-chain carboxylic acid has 3 to 9 carbon atoms. More preferably, the at least one short-chain aldehyde and/or the at least one short-chain carboxylic acid is formed by crosslinking as a function of time.

According to still another embodiment of the present invention, the at least one short-chain aldehyde (preferably having from 3 to 9 carbon atoms) and/or the at least one short-chain carboxylic acid (preferably having from 3 to 9 carbon atoms) is present at a concentration of less than 40 ppm, preferably less than 25 ppm, more preferably less than 20 ppm, less than 15 ppm, less than 10 ppm, less than 5 ppm, or less than 1 ppm

The concentration of the at least one short-chain aldehyde and/or the at least one short-chain carboxylic acid can be determined by any suitable method. For example, chromatographic methods, in particular gas chromatography and H PLC, and/or mass spectroscopy may be used. Preferably, the concentration of the at least one short-chain aldehyde and/or the at least one short-chain carboxylic acid is determined according to the examples.

Particularly preferably, the concentration of the at least one short-chain aldehyde and/or the at least one short-chain carboxylic acid is lower than or equal to the applicable maximum workplace concentration at the time of application. The maximum workplace concentration is determined in accordance with the applicable legal requirements, e.g., of the European Union, including the listed equipment, chemicals, etc. This ensures sufficient protection of employees.

Preferably, a concentration of the at least one short-chain aldehyde is determined according to DIN ISO 16000-6:2012-11.

According to still another embodiment of the present invention, the odor- and emission-reduced corrosion protection agent for cavity sealing or underbody protection has a rating of <3, preferably <2, more preferably 1, in an odor test according to VDA 270 and/or PV 3900. This ensures that the end user is only slightly annoyed, preferably not annoyed, by the odor of the at least one short-chain aldehyde and/or the at least one short-chain carboxylic acid.

Preferably, the odor test is performed according to the examples.

Preferably, the corrosion protection agent is a so-called solvent-containing cavity preservative or 100% cavity preservative. In contrast to the so-called aqueous cavity preservatives, these cavity preservatives have no water or only a low water content (e.g., less than 5% by weight of water, preferably less than 1% by weight of water or less than 0.1% by weight of water based on 100% by weight of the composition). The solvent-containing cavity preservative or 100% cavity preservative is characterized by faster and more uniform drying compared to the aqueous cavity preservative.

According to one embodiment of the present invention, the component is a vehicle component. Preferably, the component is selected from the group consisting of a motor vehicle component, rail vehicle component, commercial vehicle component, agricultural machine component, forestry machine component, construction machine component, aircraft component or marine vehicle component. More preferably, the component is a motor vehicle component.

In general, any component, or cavity, or underbody of a motor vehicle may be provided with the corrosion inhibitor of the invention. Some or all the surface of the component may be provided with the corrosion inhibitor, for example 10% or more, such as 20% or more, 30% or more, 40% or more, 50% or more, 60% or more, 70% or more, 80% or more, 90% or more, or 95% or more, of the total surface of the component may be provided with the corrosion inhibitor.

Preferably, the component is a technical component, i.e., a component that is not used in construction. More preferably, it is a motor vehicle component in the area of the cavities or the underbody.

Alternatively, the component can be a metallic component, e.g., a component made of a metal alloy, preferably steel, but also components made of fiber-reinforced composite materials, e.g., CFRP (carbon fiber reinforced plastics).

A method of providing an anti-corrosion coating to a component may have or consist of the following steps: (a) applying the of the composition to the component, and (b) drying the composition.

Preferably, a component provided or coated with the composition can be obtained by the process according to the invention.

Preferably, after step (a) of applying an anti-corrosion agent to the component, and before step (b) of drying the anti-corrosion agent, step (a1) of allowing the anti-corrosion agent to penetrate and, if necessary, (a2) of allowing excess anti-corrosion agent to drip off the component takes place.

As mentioned above, by using a Diels-Alder product, the emission development and odor nuisance can be reduced and, if necessary, completely avoided, both during the actual manufacturing process, but also of the finished anti-corrosion coating. This has the advantage that the odor of a finished motor vehicle can be influenced more easily by the automobile manufacturer or the purchaser in a desired manner.

It is understood that the above features and those to be explained below are used not only in the combination indicated in each case, but also in other combinations or in a stand-alone position, without departing from the scope of the present invention.

The invention is explained in more detail below with the aid of examples.

### EMBODIMENTS

### Example 1

The following is a procedure for odor evaluation of a corrosion inhibitor.

I. Purpose and scope: This method has been developed in accordance with VDA 270/PV 3900 and is used to evaluate the odor behavior of a corrosion protection agent, in particular HRK material, under the influence of temperature.
II. definition: Odor behavior is understood as the readiness of substances to emit volatile components that result in a perceptible odor.
III. principle: The odor is evaluated olfactorily by a selected odor panel of at least 3 persons, after preconditioning followed by temperature exposure. A size of the odor panel of 5 persons is recommended.
IV. Devices used:
Laboratory stirrer, e.g., IKA stirrer 20.n and inclined blade stirrer, 4 blades made of stainless steel
Cold-rolled steel sheet or odorless, clean aluminum foil (approx. 10 cm×20 cm)
Odorless, clean aluminum foil
Aluminum bowl: Canning jar ø 64 mm; Type: 550028; Mat.-No.: 3201964; Fa. Novelis Deutschland GmbH
1-liter glass containers with odorless seal and lid are used as testing devices, e.g., 1 L preserving jars from Leifheit (Frucht & Fun).
Heating chamber with air circulation (drying oven), e.g., Heraeus UT 6200

### V. Implementation:

### V.1 Sample Preparation

### a) Spray Waxes

Stir sample material (viscous cavity preservative) for 15 min at 1000 min⁻¹
Apply sample material with a film drawing frame onto a steel sheet or aluminum foil (10 cm×20 cm) with a wet film thickness of 200 μm.
Activation of the samples for 5 min at 65° C. in the drying oven
Preconditioning of the sheets for 7 days at (23±2) ° C. and (50±5) % relative humidity.
Apply mg of the dried product (100±5) to a piece of aluminum foil (5 cm×5 cm) with a spatula
Place the 5 cm×5 cm piece of aluminum foil containing (100±5) mg of product on the bottom of the test vessel and seal it

### (b) Flood Waxes:

Weigh 1 g of the sample material into an aluminum dish (ø 64 mm canning jar).
Place aluminum dish with 1 g sample material on the bottom of the test vessel and close it

### c) Raw Materials:

Weigh 1 g of the sample material into an aluminum dish (ø 64 mm canning jar).
Place aluminum dish with 1 g sample material on the bottom of the test vessel and close it

### V.2 Storage Conditions and Odor Test

All the tests listed below are performed.

### a) Spray Waxes:

TABLE 1.1
Storage conditions for spray waxes

| | Temperature | Storage | Test |
|---|---|---|---|
| Condition | in ° C. | condition | note |
| 1 | 40 ± 2 | 2 h ± 10 min | a), b) |
| 2.1 | 40 ± 2 | 7 d ± 0.5 d | a), b) |
| 2.2 | 105 ± 2 | 2 h ± 10 min | c) |

### (b) Flood Waxes:

TABLE 1.2
Storage conditions for flood waxes

| | Temperature | Storage | Test |
|---|---|---|---|
| Condition | in ° C. | condition | note |
| 3 | 80 ± 2 | 2 h ± 10 min | d) |

### c) Raw Materials:

TABLE 1.3
Storage conditions for raw materials

| | Temperature | Storage | Test |
|---|---|---|---|
| Condition | in ° C. | condition | note |
| 1 | 40 ± 2 | 2 h ± 10 min | a), b) |
| 2.1 | 40 ± 2 | 7 d ± 0.5 d | a), b) |
| 3 | 80 ± 2 | 2 h ± 10 min | d) |

### Test Notes

The odor evaluation takes place directly after the test vessel has been removed from the drying oven. The test vessel is then closed again.
Re-odor evaluation of the test vessel from a) after storage for 1 day at room temperature.
Storage analogous to condition 2.1 and evaluation according to a) and b). The test vessel is then closed again and stored at 105° C. (condition 2.2). This is followed by an odor evaluation after storage for 7 days at room temperature.
After removal from the oven, the test vessel is cooled for 5 min and then olfactorily evaluated

### VI. Odor Evaluation

The odor evaluation is performed according to the current version of VDA 270. All possible conditions are evaluated with the grades described in Table 1.4. Grades are awarded from 1 to 6, with the award of half grades being possible.

TABLE 1.4
Grading scale odor evaluation

| Note | Description |
|---|---|
| 1 | indiscernible |
| 2 | perceptible, not disturbing |
| 3 | clearly perceptible, but not yet disturbing |
| 4 | disturbing |
| 5 | strongly disturbing |
| 6 | unbearable |

The result of the determination of odor behavior is given as an arithmetic mean. The scores are rounded in such a way that a gradation of half note increments is produced.

### Example 2

The following is another method for emission assessment of a corrosion inhibitor.

### I. Purpose and Scope:

This method is used to characterize the type and quantity of outgassable organic substances consisting of non-metallic materials used in vehicle interiors. The individual substances are quantified as toluene equivalent.

### II. Principle:

For sampling, the materials are placed in a micro test chamber at a defined temperature and flow. Here, thermal extraction of the analytes on Tenax TA® takes place. The analytes (emissions) are subsequently separated by gas chromatography and detected by mass spectrometer. The measured values obtained from this test method are only valid for the conditions described here. The results obtained are not suitable for making health assessments of the detected substances. The measurement results are also not suitable for making estimates of the total emissions of a vehicle.

### III. Devices:

Micro-Chamber/Thermal Extractor™ (μ-CTE™); 6 chamber model; Fa. Markes International
Rotilabo® aluminium dishes with handle; ø 28 mm, 8 ml; order no. PP54.1; Carl Roth GmbH & Co. KG
Glass tubes; ¼″×3½″; Tenax TA; C6-C30; Conditioned & Capped; Article no.: C1-BAXX-5039; Fa. Markes International
FlowMark™ flowmeter; 0.5 ml/min to 500 ml/min; article no.: N9307086; Perkin Elmer Co.
TD 100xr; Thermodesorber; Fa. Markes International
Cold Trap “General Purpose Hydrophobic; Article No.: U-T2GPH-2S; QC: QQR-0145
GCMS 2010; Shimadzu Company
GCMS QP 2010; Mass spectrometer; Fa. Shimadzu
μl syringe for standard injection, e.g., 5 μl syringe; Fa. SGE Analytical Science

### IV. Implementation:

### IV.1 Sample Preparation

### a) Spray Waxes:

Stir sample material (viscous cavity preservative) for 15 min at 1000 min⁻¹
Weigh out approx. 150 mg of sample material exactly into an aluminum dish (Rotilabo® aluminum dishes with handle; ø 28 mm) (label the aluminum dish by scoring it with a pointed object, e.g., tweezers).
Activation of the samples for 5 min at 65° C. in the drying oven
Precondition the aluminum dishes for 7 days at (23±2) ° C. and (50±5) % relative humidity.

### (b) Flood Waxes:

Weigh out approx. 150 mg of sample material exactly into an aluminum dish (Rotilabo® aluminum dishes with handle; ø 28 mm) (label the aluminum dish by scoring it with a pointed object, e.g., tweezers).

### c) Raw Materials:

Stir sample material (if liquid) for 15 min at 1000 min⁻¹ Weigh out approx. 150 mg of sample material exactly into an aluminum dish (Rotilabo® aluminum dishes with handle; ø 28 mm) (label the aluminum dish by scoring it with a pointed object, e.g., tweezers).
Possibly activate the specimens for 5 min at 65° C. in the drying oven (see IV.3 Test instructions).
Possibly precondition the aluminum dishes for 7 days at (23±2) ° C. and (50±5) % rel. humidity. (see IV.3 Test instructions)

### IV.2 Sampling

Sampling is performed using a Micro-Chamber/Thermal Extractor™ (μ-CTE™). Before using the μ-CTE™, it is cleaned with isopropanol. To ensure that all isopropanol is removed before sampling, the chamber is heated to the maximum temperature of 120° C. for 30 min after cleaning and a flow of approx. 40 ml/min is set. The flow is set and checked with the aid of the FlowMark™ flowmeter from PerkinElmer. Sampling is performed on glass tubes filled with Tenax TA (TD tubes). These TD-Tubes are conditioned prior to use to eliminate contamination from the previous analysis, among other things. Conditioning is performed as described in section IV 4.4. For sampling, the TD-Tubes are attached to the outlet of the μ-CTE™.

For all samples, a reference must be co-measured as a benchmark, since an assessment should only be made relative to a co-measured sample. The sampling parameters can be Tablebe taken from Table 2.3. As a rule, test condition 1 is used. Test condition 2 is only used if an intensification of the signals (obtained from condition 1) is necessary or if the customer specification requires it.

### a) Spray Waxes:

TABLE 2.1
Sampling conditions for spray waxes

| | Temperature | Flow in | Sampling |
|---|---|---|---|
| Condition | in ° C. | ml/min | time in min |
| 1 | 65 ± 2 | 40 | 30 |
| 2 | 90 ± 2 | 40 | 30 |

### (b) Flood Waxes:

TABLE 2.2
Sampling conditions for flood waxes

| | Temperature | Flow in | Sampling |
|---|---|---|---|
| Condition | in ° C. | ml/min | time in min |
| 1 | 65 ± 2 | 40 | 30 |
| 2 | 90 ± 2 | 40 | 30 |

### c) Raw Materials:

TABLE 2.3
Sampling conditions for raw materials

| | Temperature | Flow in | Sampling | Test |
|---|---|---|---|---|
| Condition | in °C | ml/min | time in min | notes |
| 1 | 65 ± 2 | 40 | 30 | |
| 2 | 90 ± 2 | 40 | 30 | |
| 3 | 65 ± 2 | 40 | 30 | a), b) |
| 4 | 90 ± 2 | 40 | 30 | a), b) |

### IV.3 Test Instructions

a) Activation of the samples for 5 min at 65° C. in the drying oven
b) Precondition the aluminum dishes for 7 days at (23±2) ° C. and (50±5) % relative humidity.

### IV.4 Analysis of the Samples

The analytical separation of the samples is performed by gas chromatography (GCMS 2010). Thermodesorption (TD 100xr) is used for sample application. Detection is performed using a mass spectrometer (GCMS QP 2010). The measurement is performed for all samples using the instrument parameters described in Section IV.4 Analysis of Samples, Tables 2.4 to 2.10. Once a week, an Auto-Tune must be performed on the gas chromatograph to ensure optimal detector voltage and to check the tightness of the system. The respective measurements must always be performed with the current Auto-Tune version.

### IV.4.1 Thermodesorption

The TD 100xr device from Markes International is used for thermodesorption. The “General Purpose Hydrophobic” cold trap is used as the cold trap. It is designed for the analysis of VOCs (volatile organic compounds) in the range of C4/5 to C30/32.

TABLE 2.4
Cold trap parameters
Cold trap parameters

| | |
|---|---|
| Maximum working temperature in ° C. | 335 |
| Typical conditioning temperature in ° C. | 300 to 320 |
| Typical desorption temperature in ° C. | 250 to 300 |

TABLE 2.5
General information on the thermal desorber
General information

| Name | Marks TD |
|---|---|
| Instrument | TD100-S2, TD100 |
| | Split, TD100 Trap |
| Mode | TD 100-S2.2-3 |
| | Stepwise desorption |
| Carrier gas | Helium |
| TD100 Type | Series 2 |
| Load Temperature in ° C. | 50 |
| Ultra Unload | 100 |
| Temperature in ° C. | |

TABLE 2.6
General setting on the thermodesorber
General settings

| Standby Split | On |
|---|---|
| Standby flow in ml/min | 25 |
| Flow Path Temperature in ° C. | 180 |
| Overlap | Off |
| GC cycle time in min | 30 |
| Minimum Carrier Pressure in psi | 10 |

TABLE 2.7
Settings for pre-desorption on the
thermodesorber Predesorption

| Standard Injection Type | Prepurge time (min) |
|---|---|
| Prepurge Time in min | 1 |
| Prepurge Trap in Line in min | Off |
| Purge Trap Flow in ml/min | 50 |
| Prepurge Split | On |
| Prepurge Split flow in ml/min | 40 |

TABLE 2.8
Settings for tube desorption on
the thermodesorber
Tube desorption

| | |
|---|---|
| Desorb Time in min | 10 |
| Desorb Temperature in ° C. | 280 |
| Trap in Line Desorb | On |
| Trap Desorb Flow in ml/min | 40 |
| Desorb Split | Off |
| Desorb Split Flow in ml/min | 50 |
| Tube Desorb 2 | Off |
| Desorb Time 2 in min | 10 |
| Desorb Temperature 2 in ° C. | 250 |
| Trap in Line Desorb 2 | On |
| Trap Desorb Flow 2 in ml/min | 50 |
| Desorb Split 2 | Off |
| Desorb Split Flow 2 in ml/min | 50 |

TABLE 2.9
Settings on the cold trap on the thermodesorber
Settings on the cold trap

| | |
|---|---|
| Trap Purge Time in min | 1 |
| Trap Purge Flow in ml/min | 40 |
| Trap Low Temperature in ° C. | 5 |
| Trap Heating Rate in ° C./s | Max |
| Trap High Temperature in ° C. | 290 |
| Trap Desorb Time in min | 10 |
| Trap Desorb Split in ml/min | On |
| Trap Desorb Flow in ml/min | 20 |

### IV.4.2 Chromatography

The GCMS 2010 from Shimadzu is used for gas chromatographic separation. An Optima 5 MS column from Macherey-Nagel with a length of 50.0 m, a thickness of 5.00 μm and a diameter of 0.32 mm or equivalent is used. The oven temperature at the start is 40° C. and the equilibration time is 3.00 min.

TABLE 2.10
Temperature program gas chromatograph

| | Rate in | Final temperature | Holding time |
|---|---|---|---|
| | ° C./min | in ° C. | in min |
| 0 | — | 40 | 4.00 |
| 1 | 3.00 | 92 | 2.00 |
| 2 | 5.00 | 160 | 2.00 |
| 3 | 10.00 | 280 | 14.07 |

### IV.4.3 Mass Spectrometer

The GCMS QP 2010 mass spectrometer is directly connected to the gas chromatograph and is also from Shimadzu. It is a quadrupole MS with an electron impact ionization source.

TABLE 2.11
MS parameters
Mass spectrometer

| | |
|---|---|
| Temperature ion source in ° C. | 200 |
| Interface temperature in ° C. | 200 |
| Solvent cutoff in min | 5,00 |
| Threshold | 40 |
| Start time MS in min | 5 |
| End time MS in min | 65 |
| ACQ mode | Scan |
| Event time in sec | 0.5 |
| Scanning speed | 769 |
| Start MS scan at m/z | 29 |
| End MS scan at m/z | 400 |

### IV.4.4 Conditioning of the Thermodesorption Tubes

The TD tubes are conditioned directly in the thermodesorber. For this purpose, the parameters given in Table 2.12, Table 2.13 and Table 2.14 are applied.

TABLE 2.12
General settings for conditioning
thermodesorption tubes
General settings

| Standby Split | On |
|---|---|
| Standby flow in ml/min | 10 |
| Flow Path Temperature in ° C. | 150 |
| Minimum Carrier Pressure in psi | 5 |

TABLE 2.13
1Tube purge settings for conditioning
thermodesorption tubes
Tube Purge

| | |
|---|---|
| Prepurge Time in min | 1 |
| Prepurge Split flow in ml/min | 50 |

TABLE 2.14
Tube desorption settings for conditioning
thermodesorption tubes
Tube desorption

| | |
|---|---|
| Desorb Time in min | 10 |
| Desorb Temperature in in ° C. | 250 |
| Tube Desorb Split in ml/min | 50 |
| Tube Desorb 2, 3 and 4 | Off |
| Desorb Time 2, 3 and 4 in min | 10 |
| Desorb Temperature 2, 3 and 4 in ° C. | 250 |
| Desorb Split 2, 3 and 4 in ml/min | 50 |

### V. Calibration

### V.1 Preparation of the Calibration Solution

For calibration, a calibration solution of toluene in methanol with a concentration of 0.5 μg/μl is prepared. For this purpose, approx. 25 mg of toluene (p.a.) are weighed accurately into a 50 ml volumetric flask and filled up to the mark with methanol (p.a.). The shelf life of the solution is 3 months when stored in a refrigerator. Labeling of the solution with the date of manufacture, contents and expiration date must be clearly visible.

### V.2 Measuring the Calibration Solution

The calibration solution is acclimatized to room temperature. For measurement, 4 μl of the calibration solution is added directly into a thermodesorption tube filled with Tenax TA using a μl pipette. The solution is dispensed as indicated on the thermodesorption tube by means of the arrow.

Subsequently, the TD tube is flown through with inert gas (helium or nitrogen) for one minute at a flow rate of about 1 l/min to 3 l/min. This ensures that the analyte is adsorbed by the Tenax-TA® and the content of excess solvent (methanol) is largely reduced. The measurement is conducted with the same method as the measurement of the samples (see section IV). A triplicate determination has to be performed.

### V.3 Evaluation and Calculation of the Response Factor

The evaluation is conducted via the area of the peak. For this purpose, the toluene peak is integrated (“link point”) and the area is determined. This is done for all three measurements. Subsequently, with the aid of the peak areas determined, the response factor is calculated according to equation 1:

$${R}_{f} = \frac{μ g toluene ( C 16 )}{peak area} * 1000000 \qquad Equation 1$$

### VI. Emission Evaluation

Emission evaluation is conducted according to the respective question. Peaks that must be evaluated in any case are aldehydes and carboxylic acids. The total content of organic compounds over the entire chromatogram (TVOC) is also evaluated. The emission values are given in each case as toluene equivalents in μg/g of sample weight. Toluene equivalents are calculated by using the peak areas and a previous calibration (see section 0). An evaluation of the respective samples is always conducted relative to a co-measured reference sample. Equation 2 is used to calculate the emission values. The response factor (Rf-value) is calculated from the calibration (see section 0).

$$Emission [ \frac{μ g}{g} ] = {R}_{f} * \frac{peak area [ counts ]}{1 \; 000 * sample weight [ mg ]} \qquad Equation 2$$

### Example 3

Three exemplary 100% cavity preservatives (HRK) have the ingredients listed in Table 3.1 below in weight percent:

Here, “100% HRK” is a conventional cavity preservative in which soybean oil is used as the alkyd resin. 100% HRK 1 and 100% HRK 2 show results for a cavity preservative according to the invention, in which once the soybean oil was reacted in advance with cyclopentadiene in a Diels-Alder reaction (100% HRK 1), or in which an alkyd resin with predominantly conjugated double bonds was used (100% HRK 2).

TABLE 3.1
Compositions of the tested cavity preservatives

| | | | 100% | 100% | 100% |
|---|---|---|---|---|---|
| CAS No. | Trade name | Functionality | HRK | HRK 1 | HRK 2 |
| 64742-55-8 | Mineral oil cut 75 | Mineral oil | 5.00 | 5.00 | 5.00 |
| 64742-54-7 | Mineral oil cut 300 | Mineral oil | 46.00 | 46.00 | 46.00 |
| 68584-23-6, | Calcium sulfonate | Corrosion- | 21.00 | 21.00 | 21.00 |
| or | | protective | | | |
| 70024-69-0 | | additive | | | |
| 68333-62-0 | Soybean oil alkyd resin | Binder | 10.00 | — | — |
| 68512-80-1 | Modified soybean oil alkyd resin | Binder | — | 10.00 | — |
| | Alkyd resin with pre-dominantly | Binder | — | — | 10.00 |
| | conjugated double bonds | | | | |
| 96-29-7 | MEKO | Skin | 0.15 | 0.15 | 0.15 |
| | | preventer | | | |
| 136-52-7 | Cobalt bis(2-hexylethanoate) | Dryer | 0.10 | 0.10 | 0.10 |
| 89749-78-0 | Bentone sd 1 | Layered | 0.25 | 0.25 | 0.25 |
| | | silicate | | | |
| 471-34-1 | Precipitated CaCO₃ | Filler | 13.50 | 13.50 | 13.50 |
| 8002-74-2 | Kerosene wax | Wax | 4.00 | 4.00 | 4.00 |

### Example 4

Results of odor determination 100% HRK, 100% HRK 1 and 100% HRK 2 from Example 3 according to the determination procedures in Example 1 (Table 4.1) and Example 2 (Table 4.2).

TABLE 4.1
Odor determination according to example 1

| Odor in accordance | 100% | 100% | 100% |
|---|---|---|---|
| with VDA 270 | HRK | HRK 1 | HRK 2 |
| Odor grade:2 h/40° C. | 3.5 | 2.5 | 3.0 |
| Odor grade:2 h/40° C. + 1 d RT | 3.5 | 3 | 3 |
| Odor grade:7 d/40° C. | 4.5 | 3 | 4 |
| Odor grade:7 d/40° C. + 1 d RT | 4 | 3.0 | 3.0 |
| Odor grade:7 d/40° C. + 1 d RT + | 3.5 | 3 | 3 |
| 2 h/105° C. + 7 d RT | | | |

Results of odor determination 100% HRK, 100% HRK 1 and 100% HRK 2 from Example 3 according to the determination procedures in Example 1 (Table 4.1) and Example 2 (Table 4.2).

### Table 4.1: Odor Determination According to Example 1

TABLE 4.2
Odor determination according to example 2

| Emission | | | | | |
|---|---|---|---|---|---|
| determination | | | | | |
| according to DIN | 100% | 100% | Reduction | 100% | Reduction |
| 16000-6 | HRK | HRK 1 | in % | HRK 2 | in % |
| Pentanal in μg/g | 5.77 | 1.97 | 65.93 | 2.35 | 59.27 |
| Hexanal in μg/g | 31.77 | 10.36 | 67.39 | 15.29 | 51.87 |
| Heptanal in μg/g | 16.32 | 0.56 | 96.54 | 2.10 | 87.13 |
| Octanal in μg/g | 8.66 | 0.53 | 93.85 | 1.25 | 85.57 |
| Nonanal in μg/g | 1.95 | 0.79 | 59.46 | 0.98 | 49.74 |

From Table 4.1 and, in particular, Table 4.2, it can be seen that the use of the corrosion inhibitor according to the invention results in a reduction in odor and emissions, which is in some cases considerable and is based on a reduced formation of short-chain aldehydes.

What is claimed is:

1. A method for preparing an odor- and emission-reduced corrosion protection agent for cavity sealing or for underbody protection of a component, comprising:
applying a composition to the component with a wet film thickness of 40 μm to 1,000 μm, wherein the composition comprises a resin, the resin comprising a plurality of molecules, the plurality of molecules comprising molecules without double allylic hydrogen atoms.

2. The method of claim 1, wherein the molecules without double allylic hydrogen atoms are first molecules, and the plurality of molecules comprise second molecules having double allylic hydrogen atoms, wherein a number ratio of the first molecules to the second molecules is at least 10³.

3. The method of claim 1, wherein the resin is a modified resin, the modified resin having a smaller number of double allylic hydrogen atoms than a non-modified resin.

4. The method of claim 1, wherein the composition comprises from 5 to 20% by weight of the resin based on 100% by weight of the odor- and emission-reduced corrosion protection agent for cavity sealing or underbody protection.

5. The method of claim 4, wherein the resin is selected from the group consisting of an unsaturated polyester, an unsaturated alkyd, resin and an unsaturated binder.

6. The method of claim 1, wherein the resin comprises no more than one of an acrylate resin and an epoxy resin.

7. The method of claim 1, wherein the composition comprises 2 to 8% by weight of a wax, based on 100% by weight of the composition.

8. The method of claim 7, wherein the wax is selected from the group consisting of a mineral wax, a fossil wax, and a natural wax.

9. The method of claim 1, wherein the composition comprises from 40 to 70% by weight of an oil, based on 100% by weight of the composition.

10. The method of claim 9, wherein the oil is selected from the group consisting of a mineral oil.

11. The method of claim 1, wherein, after a reaction, the odor- and emission-reduced corrosion protection agent for cavity sealing or underbody protection can be exposed to a temperature of 70° C. or more for a period of 5 minutes to 2 hours without the reacted odor- and emission-reduced corrosion inhibitor exhibiting detectable change.

12. The method of claim 1, wherein, after a reaction, the odor- and emission-reduced corrosion protection agent for cavity sealing or underbody protection can be exposed to a temperature of −15° C. or less for a period of 5 minutes to 2 hours without the reacted odor- and emission-reduced corrosion protection agent exhibiting detectable changes.

13. The method of claim 1, wherein the odor- and emission-reduced corrosion protection agent for cavity sealing or underbody protection comprises less than 100 ppm of at least one short-chain aldehyde.

14. The method of claim 13, wherein the at least one short-chain aldehyde comprises 3 to 9 C atoms.

15. The method of claim 1, wherein the odor- and emission-reduced corrosion protection agent for cavity sealing or underbody protection comprises less than 100 ppm of at least one short-chain carboxylic acid.

16. The method of claim 15, wherein the at least one short-chain carboxylic acid comprises 3 to 9 C atoms.

17. The method of claim 1, wherein the odor- and emission-reduced corrosion protection agent for cavity sealing or underbody protection has a rating of less than 3 in an odor test according to VDA 270.

18. The method of claim 1, wherein the odor- and emission-reduced corrosion protection agent for cavity sealing or underbody protection has a rating of less than 3 in an odor test according to PV 3900.

19. The method of claim 1, wherein the component is a vehicle component.

20. The method of claim 19, wherein the vehicle component is selected from the group consisting of a motor vehicle component, a rail vehicle component, a commercial vehicle component, an agricultural machine component, a forestry machine component, a construction machine component, an aircraft component, or a marine vehicle component.
